(19) United States
(12) Patent Application Publication
(10) Pub. No.: US 2012/0267198 A1
(43) Pub. Date: Oct. 25, 2012

(54) PERSONAL FIRE SAFETY DEVICE

(76) Inventor: ROY CHOWTHI, South Richmond Hill, NY (US)

(21) Appl. No.: 13/281,876

(22) Filed: Oct. 26, 2011

Related U.S. Application Data
(60) Provisional application No. 61/517,461, filed on Apr. 21, 2011.

(51) Int. Cl. A62B 1/10; B23P 17/00; A62B 1/16

(52) U.S. Cl. 182/231; 182/3; 29/428

(57) ABSTRACT

A personal safety device for controlled-rate descent of a person from a building may include a cable control assembly having a frame attachable to the building. A cable may be wound on a cable reel. The cable reel may be configured for rotation within the frame. A weight setting control may be configured to vary a weight at which a predetermined rate of descent of a person supported on the cable will occur, whereby a user of the device can set his or her weight on the weight setting control and employ the device to descend from a building at the predetermined rate.

### CROSS REFERENCE TO RELATED APPLICATIONS

The present application claims priority to U.S. Provisional Patent application No. 61/517,461, filed Apr. 21, 2011, the entire content of which is incorporated herein by reference.

### BACKGROUND OF THE INVENTION

The present invention generally relates to apparatus and methods for egress from a location, and, more specifically, to a personal fire safety device.

In some residential buildings without dedicated exterior fire escape stairways, a cable based escape system may be provided so that a person may exit from a window and descend to ground level. Such cable based systems may allow a person to descend at a safe speed from a window of a building in the event of a fire in the building. In order to assure that person may descend at a safe speed, the escape systems may employ complex braking devices. As a consequence of such complexity, prior art cable based personal escape systems may be expensive to produce and may require periodic maintenance to assure that they will perform correctly when needed.

As can be seen, there is a need for an improved personal escape apparatus and method that may be constructed inexpensively and may remain in a state of readiness without a need for periodic maintenance.

### SUMMARY OF THE INVENTION

In one aspect of the present invention, a personal safety device for controlled-rate descent of a person from a building may comprise: a cable control assembly having a frame attachable to the building; a cable wound on a cable reel, the cable reel configured for rotation within the frame; and a weight setting control configured to vary a weight at which a predetermined rate of descent of a person supported on the cable will occur, whereby a user of the device can set his or her weight on the weight setting control and employ the device to descend from a building at the predetermined rate.

In another aspect of the present invention, a method for providing emergency cable-descent egress from an elevated portion of a building may comprise: providing a cable-descent personal safety device for attachment to a window frame of the building; and providing the safety device with a weight setting control whereby a user of the device can set his or her weight on the weight setting control and then employ the device to descend from a building at the predetermined rate.

These and other features, aspects and advantages of the present invention will become better understood with reference to the following drawings, description and claims.

### BRIEF DESCRIPTION OF THE DRAWINGS

FIG. 1 is a perspective view of a personal fire safety device in accordance with an embodiment of the present invention;

FIG. 2 is oblique perspective view of the personal fire safety device of FIG. 1 in use;

FIG. 3 is an exploded view of a cable control assembly of the personal fire safety device of FIG. 1;

FIG. 4 is an exploded view of a compression assembly of the personal fire safety device of FIG. 1;

FIG. 5 is an exploded view of an anti-backlash assembly of the personal fire safety device of FIG. 1; and

FIG. 6 is a perspective view of the personal safety device of FIG. 1 in a stand-by mode.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a personal fire safety device that allows a user to safely lower himself from a window of a building to ground level at a controlled rate of descent. More particularly, the present invention provides such an apparatus in which braking force may be pre-set in accordance with the user's weight at the time of use.

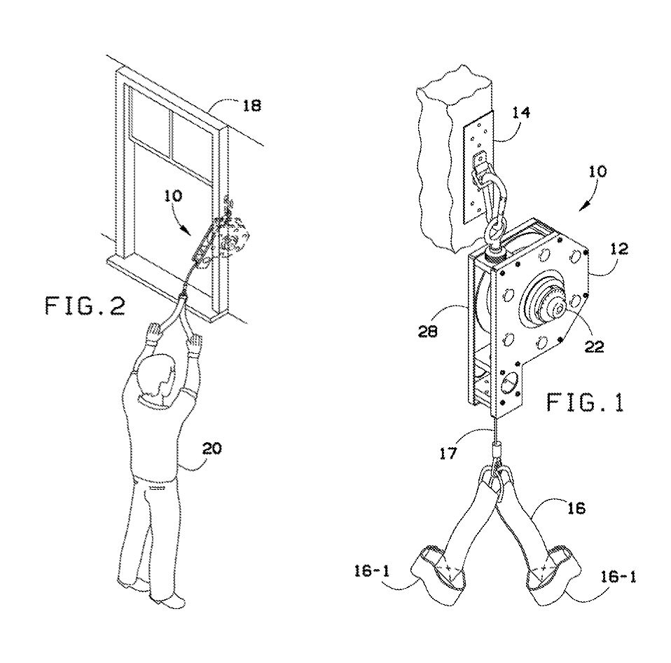

Referring now to FIGS. 1 and 2, it may be seen that an exemplary embodiment of a personal safety device 10 may comprise a cable control assembly 12, a building attachment assembly 14 and a personal support assembly 16 attached to a cable 17. The personal support assembly may be provided with wrist engaging straps 16-1. The device 10 may be installed inside a building adjacent to a window. For example, the attachment assembly 14 may be secured to an interior of a window frame 18. In operation, a person 20 may open a window, place his or her hands into the personal support assembly 16, climb out of the window and descend from the window as shown in FIG. 2. Prior to use of the device 10, a weight setting control 22 may be set at a weight value that approximates the user's weight. The weight setting control 22 may be set by the user 20 immediately prior to use of the device 10. Alternatively, the weight setting control 22 may be set to a potential user's weight when the device 10 is initially installed, and can be changed at any time to match any subsequent change in the weight of the user 20.

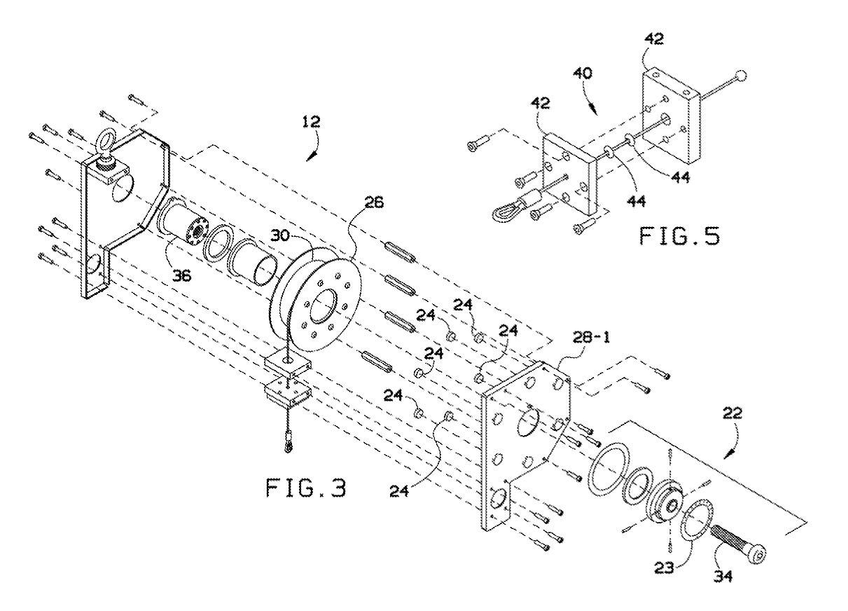

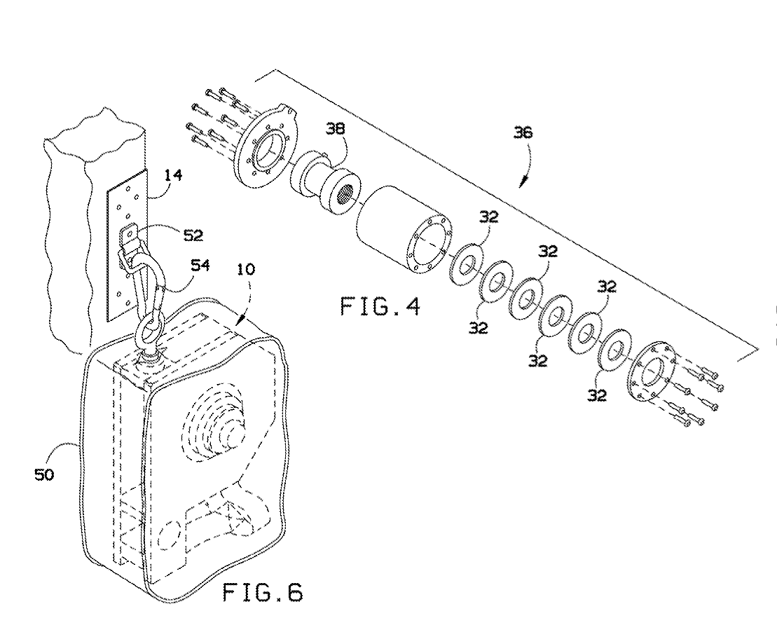

Referring now to FIGS. 3 and 4, it may be seen that the device 10 may provide for a controlled rate of descent through frictional interaction of brake pads 24 and a brake disc 26. The brake pads 24 may be adhesively secured to a frame member 28-1. The brake disc 26 may be attached to or integral with a cable reel 30 which may be rotatably mounted within the cable control assembly 12. Frictional force between the brake pads 24 and the disc 26 may be varied through interaction between the weight setting control 22 and a compression assembly 36. By turning the weight setting control 22, a screw 34 that may be threadably engaged with a nut 38 of the compression assembly 36 may vary a degree of compression of a plurality of Bellville washers 32. The weight setting control 22 may be provided with a graduated dial 23 that displays various weights in units of pounds and/or kilograms. A user may turn the control 22 until the dial 23 is positioned at his or her personal weight. Turning the control 22 may increase or release compression of the Bellville washers 32 and may thus vary the amount of axial force between the disc 26 and the brake pads 24. Such axial force may be determinative of frictional or braking force that will be applied to the disc 26 when the cable reel 30 rotates.

Referring to FIGS. 3 and 5, it may be seen that the device 10 may be provided with an anti-backlash assembly 40. The anti-backlash device may include two constraining blocks 42 and two plastic rings 44 that may fit snugly around the cable 17. The constraining blocks 42 may hold the rings 44 in position relative to the frame 28 so that the cable 17 does not unwind or backlash away from the cable reel 30 when the device 10 is in a stand-by mode.

Referring now to FIG. 6, it may be seen that the device 10 may be stored in a compact bag 50 when in a stand-by mode. The device 10 may be held in place with the building attachment assembly 14 which may include an attachment bracket 52 and a spring link 54.

It should be understood, of course, that the foregoing relates to exemplary embodiments of the invention and that modifications may be made without departing from the spirit and scope of the invention as set forth in the following claims.

What is claimed is:

1. A personal safety device for controlled-rate descent of a person from a building comprising:
a cable control assembly having a frame attachable to the building;
a cable wound on a cable reel, the cable reel configured for rotation within the frame; and
a weight setting control configured to vary a weight at which a predetermined rate of descent of a person supported on the cable will occur, whereby a user of the device can set his or her weight on the weight setting control and employ the device to descend from a building at the predetermined rate.

2. The personal safety device of claim 1 further comprising:
one or more brake pads attached to the frame; and
a brake disc attached to or integral with the cable reel,
the brake pads being engaged with the brake disc with an axial force that is adjustable responsively to the weight setting control.

3. The personal safety device of claim 2 comprising a plurality of the brake pads wherein the brake pads are adhesively secured to a frame member.

4. The personal safety device of claim 1 further comprising:
a compression assembly configured to apply variable axial force on the cable reel,
wherein the weight setting control is interconnected with the compression assembly control so that rotation of the weight setting control causes variation of the axial force on the cable reel applied by the compression assembly.

5. The personal safety device of claim 4 wherein the compression assembly includes a plurality of Bellville washers.

6. The personal safety device of claim 4 wherein:
the weight setting control includes a threaded screw;
the compression assembly includes a threaded nut; and
the screw and the nut are threadably engaged with one another so that turning the weight setting control varies the axial force produced by the compression assembly.

7. The personal safety device of claim 1 further comprising a personal support assembly attached to the cable, the personal support assembly including wrist engaging straps.

8. The personal safety device of claim 1 further comprising an anti-backlash assembly that includes:
at least two constraining blocks; and
at least two plastic rings snugly fitted on the cable and interposed between the two constraining blocks.

9. The personal safety device of claim 1 further comprising a building attachment assembly that includes:
a bracket; and
a spring link interposed between the bracket and the frame.

10. A method for providing emergency cable-descent egress from an elevated portion of a building comprising:
providing a cable-descent personal safety device for attachment to a window frame of the building; and
providing the safety device with a weight control setting control whereby a user of the device can set his or her weight on the weight setting control and then employ the device to descend from a building at the predetermined rate.
